(19) United States
(12) Patent Application Publication
(10) Pub. No.: US 2012/0156582 A1
(43) Pub. Date: Jun. 21, 2012

(54) FUEL CELL

(75) Inventors: Shanwen Tao, Glasgow (GB); Rong Lan, Glasgow (GB)

(73) Assignee: UNIVERSITY OF STRATHCLYDE, Glasgow (UK)

(21) Appl. No.: 13/322,042

(22) PCT Filed: May 24, 2010
(86) PCT No.: PCT/GB2010/001031

§ 371 Date: Mar. 8, 2012

(30) Foreign Application Priority Data
May 22, 2009 (GB) 0908910.3

(51) Int. Cl. H01M 8/10; H01M 4/90; H01M 8/24; H01M 8/04; H01M 8/22; B82Y 30/00

(52) U.S. Cl. 429/454; 429/479; 429/495; 429/492; 429/491; 429/490; 977/777; 977/773

(57) ABSTRACT

The invention provides a method of operating a fuel cell comprising a solid anion exchange membrane, the method comprising contacting an anode in the fuel cell with urea, ammonia or an ammonium salt and contacting the cathode with an oxidant whereby to generate electricity.

### FIELD

The present invention relates to a method for using a fuel cell, in particular a fuel cell comprising an anion exchange membrane, which consumes urea, ammonia, or an ammonium salt as fuel to generate electricity. The invention also provides a fuel cell comprising an anion exchange membrane and urea, ammonia, or an ammonium salt and an apparatus comprising such a fuel cell and a method of powering an apparatus by harnessing the electricity generated from operating a fuel cell according to the method of the invention.

### BACKGROUND

Fuel cell technology is now well recognised as having the potential to help address the energy crisis as the world's finite supply of fossil fuels becomes exhausted. Thus the application of fuel cell technology is likely to play a pivotal role in combating both the looming energy crisis and also climate change.

As is known, a fuel cell is an electrochemical apparatus that generates electricity from fuel and oxidant supplied to it. In a fuel cell the fuel is consumed and electrons are generated on the anode side. The electrons generated are forced through an external circuit to the cathode where they react with the oxidant, typically oxygen present in air. The anode and cathode are separated by an electrolyte but connected by an external circuit through which the electrons generated flow from anode to cathode, thereby allowing electrical power to be harnessed.

Very broadly speaking, many fuel cells fall into two categories. In the first, so-called Proton Exchange Membrane Fuel Cells, or sometimes Polymer Electrolyte Membrane Fuel Cells (both PEMFC), hydrogen or other substrates function as the fuel resulting in the generation of protons and electrons at the anode. The electrons pass through the external circuit to the cathode and the protons pass through the polymeric electrolyte membrane to the cathode. There, the protons, electrons and the oxidant (typically oxygen), combine to form water molecules. PEMFCs employ an acidic proton-conductive polymeric membrane, typically a cast or extruded film of appropriate thickness to provide mechanical barrier properties (so as to separate the cathode and anode) yet allowing rapid transport of protons. The most well known membrane used in PEMFCs is DuPont's Nafion™, a poly-sulfonated perfluoropolymeric material described in U.S. Pat. No. 3,718,627 (to Grot et al.).

In addition to using hydrogen as such as the fuel in fuel cells, including PEMFCs, a variety of hydrogen-containing fuels have been employed in fuel cells, which are reformed to provide the hydrogen fuel. In addition, so-called direct fuel cells oxidize the fuel (and so use the fuel directly) without subjecting it to an initial reforming step to provide the hydrogen that is reacted at the anode in indirect fuel cells. Hydrogen-fuelled fuel cells could therefore be regarded as “direct hydrogen fuel cells”. Typically, however, the use of fuels other than hydrogen are intended, including herein, when reference is made to direct fuel cells. Examples of direct fuel cells reported to date include those based upon bororohydrides, methanol and formic acid.

The second category into which many fuel cells fall does not rely on the passage of protons through the electrolyte but rather the passage of hydroxide anions. The “classic” alkaline fuel cell was developed by Francis Bacon (and so is sometimes referred to as the Bacon fuel cell) and comprises a liquid alkaline electrolyte, such as potassium hydroxide, typically saturated within a porous non-electrolytic support. Recently, however, efforts have been made to develop an alkaline fuel cell comprising a solid membrane, i.e. a hydroxide anion exchange membrane, in effect an all solid-state alkaline fuel cell. It should be noted, however, that such the term “alkaline fuel cell” is used primarily in the art to refer to Bacon fuel cells. Given this, there appears to be less consensus as to how to refer to “solid-state alkaline fuel cells” although alkaline membrane fuel cells (AMFCs) is an accurate description.

Whether or not PEMFCs or AMFCs use hydrogen as the fuel from which protons and electrons are generated at the anode, since the ability to generate protons at the anode is a requirement in PEMFCs—direct methanol fuel cells for example generating protons, electrons and carbon dioxide at the anode from methanol and water—the ability to provide a on-board hydrogen storage facility persists as a challenge and as a limitation to the use of fuel cells in transport applications. Hydrogen can be stored in low molecular weight compounds such as ammonia, methane and methanol, which molecules contain 17.6, 25.0 and 12.5 wt % hydrogen respectively. Notably the energy density of liquid ammonia in particular is very high. Thus, for on-board storage of 4 kg hydrogen, 125 litres are required at a pressure of 500 bar, 47 litres if liquid hydrogen is used, but only 45 litres of the hydrogen is provided by liquid ammonia. The energy density of urea is higher than compressed or liquid hydrogen which also makes it a potential energy carrier. As a solid powder, urea is particularly easily stored and transported. Urea effectively contains 10 wt % hydrogen and is a potential indirect hydrogen storage material.

Up until recently, of the approaches for using ammonia in fuel cells that have been described, most involve the conversion (reforming) of ammonia to hydrogen and nitrogen at high temperature (see for example L Li & J A Hurley (Inter. J. Hydrogen Energy, 32, 6-10 (2007)). Mention is also made in U.S. Pat. No. 7,140,187 (to Amendola) of ammonia fuel cells for oxidising ammonia to water and nitrogen. The patent mentions, as examples of fuel cells, high temperature fuel cells such as solid oxide fuel cells and molten carbonate fuel cells and lower temperature fuel cells such as alkaline fuel cells and phosphoric acid fuel cells. An ammonia fuel cell based on molten KOH electrolyte has been described by J C Ganley (J. Power Sources, 178 (1), 2008, 44-47).

As noted above, the most common approach by which ammonia is employed in PEMFCs is to convert ammonia to hydrogen and nitrogen at high temperature (L Li et al., infra). However, any unconverted (unreformed) ammonia will damage the acidic electrolyte present in PEMFCs. It has recently been reported (T Hejze et al. (J. Power Sources, 176, (2008), 490-493)) that one way to address the problem of using ammonia with PEMFCs is by using ammonia as the fuel in an alkaline fuel cell. As is known, alkaline fuel cells comprise an electrolyte interposed between cathode and anode constituted by an aqueous alkaline solution, e.g. potassium hydroxide present as a solution within a porous matrix. Hejze et al. (ibid) describe an alkaline fuel cell separated at 85° C. comprising platinum at the cathode and anode.

The use of urea as a fuel source for fuel cells appears to have been even less reported than has ammonia. U.S. Pat. No. 7,140,187 (infra) describes a method and apparatus for generating energy from a composition comprising urea and water. In most embodiments, however, the urea is used to provide either ammonia or hydrogen which are either oxidised to form water and energy or the ammonia is reformed to nitrogen and hydrogen the hydrogen component of which is then oxidised to form water and energy. Mention is made of the oxidation of urea in an urea fuel cell either at a temperature of about room temperature to about 200° C. or in a solid oxide fuel cell or molten carbonate fuel cell operating at a temperature between about 700° C. and about 1000° C. To the best of our knowledge there do not appear to have been any other reports of the direct use of urea in fuel cells.

Urea is a non-toxic low-cost industrial product which is widely used as fertiliser. It can be synthesised from ammonia produced from natural gas or coal in large quantities. AdBlue, a 32.5% urea solution developed by Europe's AdBlue urea-selective catalytic reduction (SCR) project, is available worldwide to remove NOₓ generated by diesel powered vehicles. Despite the widespread availability of urea, there is currently no technology able to generate electricity from urea or AdBlue.

During the industrial synthesis of urea, a large amount of waste water with varying urea concentrations is formed. A large amount of human or animal urine, containing about 2-2.5 wt % urea, is produced everyday. There is a significant level of urea in municipal waste water but the available denitrification technologies are expensive and inefficient. Recently it has been reported that hydrogen can be generated from urine or urea-rich waste water through electrolysis (B. K. Boggs, R. L. King, G. G. Botte, Chem. Comm., 2009, 32, 4859). However, to generate electricity directly from urine or urea-rich waste water would be more efficient.

K Asazawa et al. have reported (Angew. Chem. Int. Ed., 46, 8024-8027 (2007)) a direct hydrazine fuel cell comprising a solid hydroxide anion exchange polymer membrane and suggested the use of such a fuel cell for vehicles. However, to address the mutagenicity of hydrazine, the authors reported the concomitant use of a detoxification technique involving fixation of hydrazine.

There therefore remain significant challenges to be addressed in the development of economically viable and environmentally acceptable fuel cells, including fuel cells using a fuel other than hydrogen directly, particularly those suitable for use in non-stationary applications such as in transport applications. The present invention addresses at least some of these challenges.

### SUMMARY

The present invention is based upon the finding that a fuel cell comprising a solid anion exchange membrane may be operated through the direct use of urea, ammonia or an ammonium salt as the fuel. This finding is surprising given the sparcity of reports of direct fuel cells based on these substrates and the emphasis, where ammonia has been used, on its use as an indirect fuel for fuel cells using PEMFC technology.

Viewed from one aspect, therefore, there is provided a method of operating a fuel cell that comprises a solid anion exchange membrane, the method comprising contacting an anode in the fuel cell with urea, ammonia or an ammonium salt and contacting the cathode with an oxidant whereby to generate electricity.

Viewed from a second aspect, the invention provides the use of urea, ammonia or an ammonium salt, as a direct fuel for a fuel cell that comprises a solid anion exchange membrane.

Viewed from a third aspect, the invention provides a fuel cell that comprises a solid anion exchange membrane and urea, ammonia or an ammonium salt.

Viewed from a further aspect, the invention provides a fuel cell stack comprising at least two fuel cells of the invention.

Viewed from a further aspect, the invention provides a method of powering a device comprising carrying out a method of operating a fuel cell according to the present invention, and using the electricity generated thereby to power to the device.

Further aspects and embodiments of the present invention will be evidence from the discussion that follows below:

### BRIEF DESCRIPTION OF THE DRAWINGS

FIG. 1(a) shows a schematic diagram of the operating principal (working mechanism) of a direct ammonia fuel cell of the present invention showing hydroxide ions passing across the anion exchange membrane.

FIG. 1(b) shows a schematic diagram of the operating principal (working mechanism) of a direct ammonia fuel cell of the present invention showing carbonate/bicarbonate ions passing across the anion exchange membrane.

FIG. 2(a) shows respectively the theoretical open cell voltage (OCV) of ammonia/oxygen and hydrogen/oxygen fuel cells over a temperature range of 25 to 90° C.

FIG. 2(b) shows the theoretical efficiencies of these two fuel cells over a temperature range of 20 to 90° C.

FIG. 3(a) shows the OCV change against time when ammonia is introduced into a fuel cell (Cell A) described below.

FIG. 3(b) shows the ammonia/oxygen fuel cell performance at room temperature for Cell A comprising a MnO₂/C cathode and Ni/C anode.

FIGS. 4(a) and 4(b) show performance plots of hydrogen and 32.5% urea (AdBlue) solution (a) and gaseous and aqueous ammonia fuel cells (b) using different fuel cell (Cell B), the preparation of which is described below. Wet oxygen was used as oxidant.

FIG. 5(a) shows how the OCV changes when hydrogen and ammonia are introduced into a further fuel cell (Cell C comprising a MnO₂/C cathode, Ni/C anode and CPPO-PVA-based membrane electrolyte), the preparation of which is described below.

FIG. 5(b) shows performance plots of H₂/O₂ and NH₃/O₂ fuels cells at room temperature when operating Cell C at room temperature.

FIG. 6 shows the fuel cell performance of a concentrated ammonia/oxygen fuel cell and an AdBlue/oxygen fuel cell.

FIG. 7(a) shows respectively the theoretical open cell voltage (OCV) of urea/oxygen and hydrogen/oxygen fuel cells over a temperature range of 25 to 90° C.

FIG. 7(b) shows the theoretical efficiencies of these two fuel cells over a temperature range of 20 to 90° C.

FIGS. 8(a) and 8(b) show performance plots with urea solutions of varying concentrations, using a fuel cell (Cell D), the preparation of which is described below. Wet oxygen was used as oxidant.

FIGS. 9(a) and 9(b) show performance plots with urea solutions of varying concentrations, using a fuel cell (Cell E), the preparation of which is described below. Wet oxygen was used as oxidant.

FIGS. 10(a) and 10(b) show performance plots with urea solutions of varying concentrations, using a fuel cell (Cell F), the preparation of which is described below. Wet oxygen was used as oxidant.

### DETAILED DESCRIPTION

The present invention arises from the recognition that fuel cells that comprise solid membranes may be operated using urea, ammonia or an ammonium salt directly as the reactant fuel.

The skilled person will be aware of many of the fundamental principles and features of a fuel cell, for example, that these are devices that generate electricity upon oxidation of the reactant fuel supplied into an anode side of the fuel all when an oxidant is introduced to the cathode side. The electricity generated by this oxidation is harnessed by channelling the electrons generated upon oxidation of the reactant fuel through an external circuit, the anode and cathode of the fuel cell being connected by this external circuit and disposed on either side of an electrolyte. In other words, it will be understood that a fuel cell as described herein comprises an anode and a cathode in electrical communication through an external circuit, the anode being provided with a catalyst capable of catalysing the oxidation of the fuel and the cathode reduction of the oxidant. Additionally, the fuel cell is provided with an electrolyte, in the present invention a solid alkaline membrane, serving to physically separate the oxidation and reduction reactions that take place at the anode and cathode. Typically, as is known in the art, where the electrolyte membrane is a solid, it together with the electrodes and associated catalysts make up what is referred to in the art as the so-called membrane electrode assembly (MEA). Typical the electrode material of the MEA comprises carbon (e.g. carbon cloth, felt or carbon paper) in or on which the catalyst is applied.

In addition, there are provided inlets to and outlets from each of the anode and cathode regions of the fuel cell as appropriate allowing the introduction of fuel and oxidant and exit of products formed from oxidation of the fuel and reduction of the oxidant. All of the foregoing features, including the provision of an electrolytic membrane as such disposed between the cathode and the anode, are standard to all fuel cells and so known to those of a skill in the art. Accordingly, neither a detailed description of these components nor the manner in which a fuel cell is constructed, are set forth herein. That said, however, exemplary and specific embodiments of these features of fuel cells, and manners in which the present invention may be practised are set forth hereinbelow for a fuller understanding of the present invention.

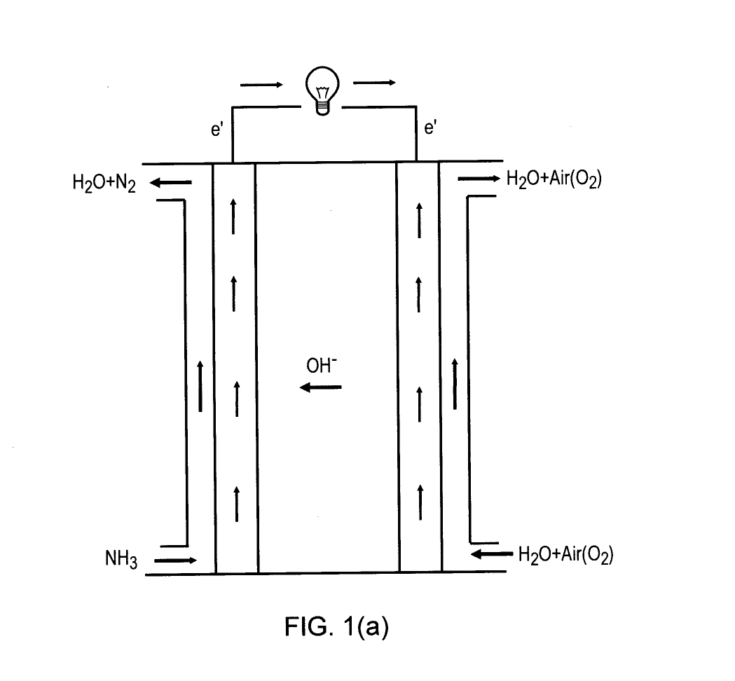

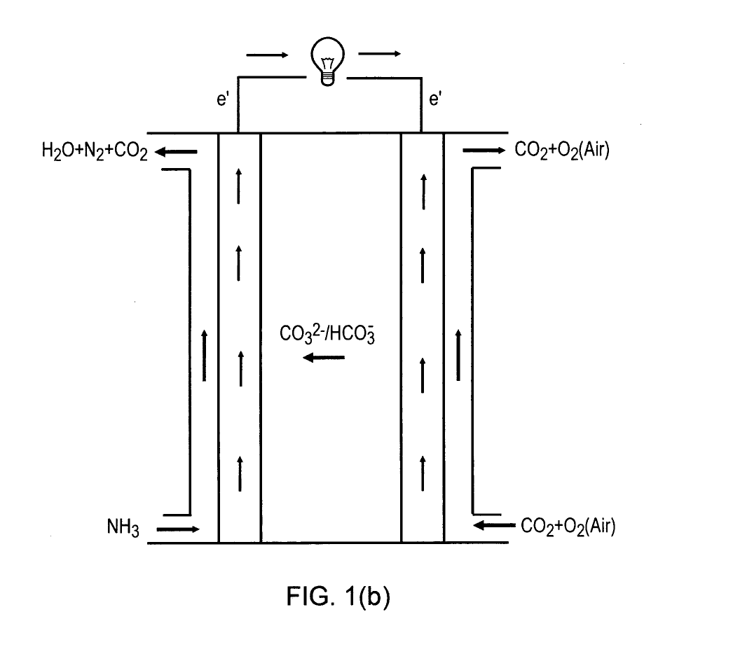

Schematic diagrams of the operation of a direct ammonia fuel cell of the invention based on hydroxide ion transportation and carbonate or bicarbonate transportation are depicted in FIGS. 1(a) and (b) respectively. The working mechanism of an ammonia fuel cell that is an AMFC is slightly different from those that use hydrogen as the fuel. Where hydroxide ions are used as the conducting species, these are generated by the reduction of oxygen to hydroxide (OH⁻) ions in the presence of water at the cathode, which is the same mechanism that takes place in hydrogen-fuelled alkaline fuel cells. Where bicarbonate or carbonate ions are used as the conducting species, these are generated by the reduction of oxygen in the presence of carbon dioxide at the cathode. The ions generated then transfer to the anode and react with ammonia to form nitrogen and water. Nitrogen is non-toxic, non-greenhouse gas. The operating mechanism of a direct ammonia fuel cell using an alkaline membrane electrolyte is described below:

$$\begin{matrix}{O}_{2} + 2 {H}_{2} O + 4 {e}^{′} \to 4 {OH}^{-} & ( cathode reaction ) & {E}^{0} = + 0.40 V \\ 2 {NH}_{3} + 6 {OH}^{-} \to {N}_{2} + 6 {H}_{2} O + 6 {e}^{′} & ( anode reaction ) & {E}^{0} = - 0.77 V \\ 4 {NH}_{3} + 3 {O}_{2} \to 2 {N}_{2} + 6 {H}_{2} O & ( overall reaction ) & {E}^{0} = 1.17 V\end{matrix}$$

If CO₃²⁻/HCO₃⁻ ions are the charge carriers in the membrane, oxygen and CO₂ (or air) provided at the cathode form CO₃²⁻/CO₃⁻ ions, and the CO₃²⁻/CO₃⁻ ions are transferred through the membrane to the anode and react with ammonia (or urea or ammonium salts) to form N₂, H₂O and CO₂.

Where urea is used as fuel, the hydrolysis of urea whereby to provide ammonia and carbon dioxide serves to provide ammonia in situ that is consumed by oxidation to nitrogen. Without wishing to be bound by theory, it is believed that the hydrolysis of urea is driven by the consumption of ammonia during operation of the fuel cell. The operating mechanism of a direct urea fuel cell using an alkaline membrane electrolyte is described below:

$$\begin{matrix}{O}_{2} + 2 {H}_{2} O + 4 {e}^{′} \to 4 {OH}^{-} & ( cathode reaction ) & {E}^{0} = + 0.40 V \\ {CO ( {NH}_{2} )}_{2} + 6 {OH}^{-} \to {N}_{2} + {CO}_{2} + 5 {H}_{2} O + 6 {e}^{′} & ( anode reaction ) & {E}^{0} = - 0.746 V \\ \underline{{CO ( {NH}_{2} )}_{2} +} 3 {O}_{2} \to 2 {N}_{2} + 2 \underline{{CO}_{2} +} 5 {H}_{2} O & ( overall reaction ) & {E}^{0} = 1.146 V\end{matrix}$$

A characteristic feature of the present invention is the provision of a solid anion exchange membrane. The fuel cells of, and used according to, the present invention are thus distinguished from the fuel cells in which alkaline electrolyte is present in solution or as a liquid. Also, of course, the membrane that serves as the electrolyte in the present invention is completely distinct from the acidic membrane used in PEMFCs.

By “solid anion exchange membrane” as used herein, therefore, is meant a solid electrolytic material capable of permitting anion conduction, e.g. transport of hydroxide, carbonate, or bicarbonate anions from a first face of the membrane to a second face of the membrane. Typically such membranes are approximately about 1-500 μm thick, e.g. about 10-250 μm thick. A large number of appropriate solid membranes are suitable, such as commercially widely available anion exchange polymers and resins (which are available in both hydroxide or halide (typically chloride) forms) used in industrial water purification, metal separation and catalytic applications. Membranes comprising halide cations (typically chloride ions) will exchange with metal hydroxides, carbonates or bicarbonates such as NaOH, NaHCO₃, Na₂CO₃ to be converted into OH⁻, HCO₃⁻ or CO₃²⁻ or mixed OH⁻/HCO₃⁻/CO₃²⁻ anion conducting membranes. Anion exchange can be effected prior to the assembly of the fuel cell, e.g. by immersion of chloride-containing membranes with an appropriate hydroxide, carbonate or bicarbonate salt. Alternatively, anion exchange can take place in situ if one or more hydroxide, bicarbonate, or carbonate salts are included with the fuel or indeed if an ammonia-based fuel is used, ammonium hydroxide itself being a base.

According to certain embodiments of the invention the membrane is a solid alkaline membrane, that is to say a solid anion exchange membrane that comprises hydroxide anions. A number of such solid alkaline membranes are suitable, these generally falling into two classes.

Firstly, there are known in the art solid polymer-containing alkaline membranes, which typically contain metal hydroxide-doped materials. A variety of polymers such as poly(sulfone-ether)s, polystyrene, vinyl polymers, such as poly(vinyl chloride) (PVC), poly(vinylidene fluoride) (PVDF), poly(tetrafluoroethylene) (PTFE) and poly(ethyleneglycol) (PEG) may be doped with a metal hydroxide, e.g. by casting a liquid mixture of one or more polymers and one or more metal hydroxides such as potassium or sodium hydroxide, onto a glass plate and evaporating the solvent(s). A specific example is the PVA-TiO₂ material described by CC Yang (J. Memb. Sci., 288, (2007), 51-16). Such metal hydroxide-containing solid alkaline membranes, however, can in certain circumstances be less than ideal because of the undesirable formation of carbonate/bicarbonate as a consequence of the reaction with carbon dioxide contaminant present with the oxidant (e.g. oxygen) at the cathode in the present of metal ions. Moreover, the use of such hydroxide-doped polymers can occasion the advantageous incorporation of further metal hydroxide into the fuel to balance any reduction in the metal hydroxide concentration in the membrane that occurs during operation of the fuel cell.

It is in part as a consequence of the disadvantage conferred by the presence of metal hydroxides, a problem also encountered in connection with alkali fuel cells, that a second type of solid alkaline membrane has been developed which are absent metal countercations to the desired hydroxide anions. These are permanently charged polymers comprising polymer-bound cations and hydroxide counterions. There are a large number of examples of these described in the literature in connection with alkaline fuel cell technology, such as polymeric electrolytic membranes used in direct methanol fuel cells. Such solid alkaline anion exchange membranes have been developed largely to try to produce a membrane for use in solid alkaline fuel cells that is analogous to the commercially available Nafion® membrane used in PEMFCs. In Nation®, the counterions (sulfonate groups) to the protons being conducted through the membrane are bound to the polymeric backbone. Analogously, therefore, a number of solid alkaline membranes have been described that comprise polymer-bound cationic counterions to the hydroxide ions that may pass through the membrane during operation of the fuel cell. These include quaternary ammonium-containing solid alkaline membranes (see, for example, T N Danks et al., J. Mater. Chem., 2003, 13, 712-721; H Herman et al., J. Membr. Sci., 2003, 218, 147-163; R C T Slade and J R Varcoe, Solid State Ionics, 2005, 176, 585-597 and a cross-linked development of the lattermost (J R Varcoe et al., Chem. Commun., 2006, 1428-1429); NJ Robertson, J. Am. Chem. Soc., 132, 2010, 3400-3404; and B. Sørensen, Hydrogen and Fuel Cells, Elsevier Academic Press, 2005. p 217). Also, there is described in WO 2009/007922 (Acta SpA) a thermoplastic-elastomeric biphasic matrix, comprising a chemically stable organic polymer grafted onto which are benzene rings bearing alkylene-linked pairs of quaternary ammonium ions, such alkylene-linked 1,4-diazabicyclo[2.2.2]octane (DABCO), N,N,N′,N′-tetramethylmethylenediamine (TMMDA), N,N,N′,N′-tetramethylethylenediamine (TMEDA), N,N,N′,N′-tetramethyl-1,3-propanediamine (TMPDA), N,N,N′,N′-tetramethyl-1,4-butanediamine (TMBDA), N,N,N′,N′-tetramethyl-1,6-hexanediamine (TMHDA) and N,N,N′,N′-tetraethyl-1,3-propanediamine (TEPDA).

In addition to solid alkaline membranes that comprise polymer-bound quaternary ammoniums ions counterions to the hydroxide ions that may pass through the membrane during operation of the fuel cell, any OH⁻ ion containing polymer without metal counterions can be used as electrolyte or ionmer in the fuel cells. One such example is tris(2,4,6-trimethoxyphenyl) polysulfone-methylene quaternary phosphonium hydroxide (TPQPOH) described by S Gu et al., Angew. Chem. Int. Ed., 48 (2009) 6499-6502).

An alkaline anion exchange membrane may be made by alkalising commercially available Morgane ADP100-2 (a cross-linked and partially fluorinated quaternary ammonium-containing anion exchange membrane sold by Solvay S. A., Belgium), as described by L A Adams et al., ChemSusChem, 1, (2008), 79-81).

Other solid alkaline membranes will be known to those of skill in the art including membranes based upon polystyrenes and poly(sulfone-ether)s, optionally for example in which the polymeric backbones are cross-linked. G Wang et al. (J. Membr. Sci., 326, (2009) 4-8) recently reported the preparation of an alternative membrane based upon a functionalised poly (ether-imide) polymer for potential fuel cells applications. This development was driven by the knowledge of the utility of aromatic poly-imides as high performance materials developed originally for the aerospace industry, and the recognition of the advantageous functional property such as high thermal stability, chemical resistance and useful mechanical properties. A further example of a solid alkaline membrane is a membrane blend developed by L Wu et al. (J. Membr. Sci., 310, 2008, 577-585) as a result of the recognition of the advantageous hydrophobicity, high glass temperature and hydrolytic stability of poly(2,6-dimethyl-1,4-phenylene oxide) (PPO): chloroacetylated PPO (CPPO) and bromomethylated PPO (BPPO)) were blended and the blend subject to alkalisation to prepare a solid hydroxide-conducting anion-exchange membrane for use in direct methanol fuel cells.

As known by those skilled in the art, all of the immediately hereinbefore described polymers have in common the ability to be dervatised whereby to provide permanently charged metal ion-free solid alkaline membranes.

Many commercially available anion exchange polymers are based on quaternary ammonium salts such as cross-linked polystyrene or styrene-divinyl benzene copolymers. In these, and other anion exchange polymers, the polymer-bound cationic counterions to the anions (e.g. hydroxide ions) may typically be introduced by reaction between halide-derivatised polymers and a tertiary amine followed by, for example alkalisation (introduction of hydroxide anions) by reaction with metal hydroxide solutions, e.g. of potassium or sodium hydroxide, with the resultant metal ion-contaminated membranes being satisfactorily rendered essentially metal ion-free by (typically) repeatedly washing with deionised water. An example is the alkaline quaternary ammonium-functionalised poly(sulfone ether) described as QAPS (quaternary ammonium polysulphone) by S F Lu et al. (Proc. Natl. Sci. USA, 105, 20611-20614 (2008)). The alkaline membrane such as A201, A901 developed by Tokuyama Corp, Japan (H Yanagi, ECS Transactions, 16 (2008) 257-262) and the FAA series membrane developed by FuMA-Tech GmbH, Germany (T Xu, J. Membrane Science, 263 (2005) 1-29) can be used in the fuel cells mentioned above.

Such metal-free, alkaline and permanently charged polymers and polymer blends may be used as the solid alkaline membrane according to the present invention.

Those of skill in the art will appreciate that one of the advantages conferred by the preparation of solid state alkaline membranes described hereinabove is avoidance of the generation of metal carbonates through the use of the membrane-bound countercations. Given this, in order to operate a fuel cell according to the various aspects of the present invention, it is not necessary for the anion exchange membrane from which the fuel cell is manufactured to comprise hydroxide ions in order for it to function as a hydroxide ion exchange membrane. This was demonstrated by L A Adams et al. (infra) who showed that the carbonate content of carbonate-functionalised Morgane ADP100-2 decreased when used in hydrogen/air and methanol air fuel cells. M Unlu et al. (Electrochemical and Solid-State Letters, 12(3) B27-B30 (2009)) also describe anion exchange membrane fuel cells using carbonate as the conductive ions. Where the oxidant supplied to the cathode is CO₂-containing air, the carbon dioxide may react under oxidising conditions within the fuel cell to form bicarbonate (HCO₃⁻) or carbonate (CO₃²⁻), bicarbonate ions being generated in the presence of water (as well as oxygen and carbon dioxide). Alternatively, CO₂ may be generated in situ from the fuel, e.g. from urea, or carbonate or bicarbonate ions may be supplied with the fuel. Because these ions do not precipitate (as carbonate or bicarbonate salts), not only may carbonate- and/or bicarbonate-containing membranes be generated in situ when operating an anion exchange membrane-containing fuel cell according to the present invention, but the anion-exchange membrane may be based on such or other anions, or on a mixture of one or more of hydroxide, bicarbonate or carbonate ions, an example being the carbonate-exchanged Morgane ADP100-2 described by L A Adams et al. (infra). In fact, Morgane ADP100-2, as an example of an anion exchange membrane, can be incorporated directly into fuel cells of or which may be used according to the various aspects of the present invention. Thus the anion-exchange membrane may comprise hydroxide ions, bicarbonate ions, carbonate ions or a mixture of these. Typically the membrane is an alkaline membrane, i.e. comprises at least some hydroxide ions, optionally with bicarbonate and/or carbonate ions, which may or may not be generated in situ.

It will be appreciated that solid anion exchange membranes, e.g. alkaline membranes, may be constituted by blends of different polymers, for example derived by alkalising the CPPO/BPPO blend membrane described by L Wu. et al. (infra). Moreover, those skilled in the art will recognise that a satisfactory combination of function (e.g. hydroxide ion conductivity) and mechanical properties may suitably be provided by providing a mixture of materials, one or more of which provides the desired anion-conducting functional property and one or more further components of which provide appropriate mechanical strength or other properties. Thus, solid hydroxide ion exchange membranes useful in the present invention may be provided that are mixtures of hydroxide anion-conducting polymers, such as those described hereinbefore, and other polymers not having such hydroxide anion-conducting properties, e.g. neutral polymers such as PVC, poly(vinyl alcohol) PVA, PEG, poly(vinyl benzene) (PVB), PTFE and PVDF. By neutral polymer is meant a polymer without cations covalently bound to the polymer. By working with mixtures of hydroxide ion-conducting polymers and polymers that do not conduct hydroxide or other anions but which have for example useful mechanical properties, desirable combinations of mechanical and functional properties may be realised through techniques with which those of skill in the art are readily familiar, such as casting from solutions and dispersions whereby to provide membranes of appropriate thickness and other dimensions. As an example of this, and in particular embodiments of the present invention, we have found alkaline membranes produced by alkalising blends of CPPO (or a commercially available anion exchange resin or polymer, for example MTO-Amberlite-IRA-400) and PVA in w/w ratios from about 20:80-80:20 (typically from about 40:60 to about 60:40 e.g., about 50:50) have suitable membrane strength and hydroxide anion transport capability.

Such solid anion exchange membranes form a yet further aspect of the present invention. Viewed from this aspect, the invention provides a solid anion exchange membrane comprising a blend of an alkaline anion exchange resin or polymer, for example MTO-Amberlite-IRA-400), and PVA in w/w ratios from about 20:80-80:20 (typically from about 40:60 to about 60:40 e.g., about 50:50).

In addition to the inclusion of neutral or other non anion-conducting polymers, the anion exchange membrane may also comprise an inorganic material, such as titanium or silicon dioxide, e.g. as particles therefore dispersed through the membrane. The skilled person is familiar with membranes comprising such materials; an example is PVA-TiO₂ material described by CC Yang (infra).

One particular advantage of fuel cell technology based upon hydroxide (or other anion, e.g. bicarbonate or carbonate) exchange instead of proton exchange as the mechanism for fuel cell design is that the use of a non-acidic, e.g. alkaline, electrolyte lessens the dependence on, and indeed can avoid the use of, noble metal catalysts in the construction of the anode and cathode in the fuel cells because other catalysts that can not withstand exposure to the acidic environment in PEMFCs can be used in the alkaline environment in AMFCs. Thus, whilst platinum- and palladium-based (particularly platinum-based, including platinum- and platinum/ruthenium-based) catalysts can be used as the both the anode and cathode when practising the methods according to the present invention, such expensive and rare metal can be avoided according to the present invention, with the electrodes made instead of non-precious catalysts such as nickel and silver.

Appropriate materials which may be used as the catalyst at the anode include titanium, vanadium, chromium, manganese, iron, cobalt, nickel, copper, zinc, molybdenum, ruthenium, rhodium, platinum, palladium, tantalum, tungsten, bismuth, tin, antimony, lead, and metal alloys, oxides, nitrides or carbides of any of the foregoing, such as metal nitrides, e.g. chromium nitride, cobalt molybdenum nitride, molybdenum carbide, platinum and platinum/ruthenium. Oxides, nitrides or carbides containing at least one of lithium, sodium, potassium, rubidium, caesium, beryllium, magnesium, calcium, strontium, barium, scandium, yttrium, lanthanides (including lanthanum) boron, aluminium, gallium, indium, tin and lead, and at least one of vanadium chromium, manganese, iron, cobalt, nickel, cooper, niobium, molybdenum, tantalum and tungsten, may also be used as the catalyst for the anode.

The catalyst present at the cathode may be made of similar materials as those from which the anodic catalyst may be manufactured; particular materials that may be suitable include copper, nickel, nickel-containing alloys, aluminium-containing alloys, nickel-containing oxides such as lithium nickel oxide, lithium manganese oxide and lithium cobalt oxide; chromium nitride, molybdenum carbide, silver, silver-containing alloys and manganese dioxide, for example, nickel, nickel-containing oxides such as lithium nickel oxide, lithium manganese oxide and lithium cobalt oxide; chromium nitride, molybdenum carbide, silver and manganese dioxide. As well as manganese dioxide, understood by those skilled in the art to refer to Mn(IV) oxide, other manganese oxides, or mixtures of manganese oxides may also be used, such as Mn(III/IV) oxide and Mn(II/III) oxide. The electrolytic manganese dioxide (EMD) used for conventional alkaline fuel cells and alkaline batteries (alkaline cells) (see for example U.S. Pat. Nos. 5,348,726, 5,516,604, 5,746,902, 6,585,881) can also be used as the cathode.

The catalysts can be used in the form of powders, mesh, foam or powders with a conducting medium such as carbon powder, carbon paper, carbon clothes, nickel foam (F Bidault et al., Inter. J. Hydrogen Energy, 34 (2009) 6799-6808; and 35 (2010) 1783-1788.)

In particular embodiments of the invention, the anode may be formed by mixing, with carbon, nano-sized particles comprising the catalytic materials described above, including nano-sized particles of metals, metal oxides, metal carbides and metal nitrides. By nano-sized particles is meant herein particles having sizes in the range of 1 to 100 nm, for example 1 to 10 nm, since such small particles sizes increase the specific surface area available for catalysis of a given amount of material. An example of nano-sized metal particles are nickel particles of approximately 2 nm in diameter (for example about 1 to 3 nm in diameter) as measured by TEM. Such nanoparticles may be prepared generally in accordance with the teachings of S Lu et al. (infra). Sizes may be established by use of transmission electron microscopy. The procedure described by Lu et al. may be varied by inclusion of Na₃C₆H₅O₇.2H₂O when preparing the nano-sized nickel particles. We find the particles may be dried at room temperature.

In particular embodiments of the invention, the cathode may be constituted by a mixture of carbon and nano-sized manganese dioxide particles. Appropriate particles can be prepared in accordance with the teachings of C Xu et al. (J. Power Sources, 180 (2008) 664-670). The resultant manganese dioxide particles provide advantageously higher surface area over manganese oxide prepared by other methods.

The present invention relies upon the direct supply to a fuel cell of urea, ammonia or an ammonium salt. Typically, where ammonia is used as the fuel this is supplied as gaseous ammonia or an aqueous solution of ammonia. Ammonium salts, or solutions thereof, may also be used. Accordingly the present invention is distinct from prior art in which the use of these chemicals as fuels is described where one of these compounds is initially reformed, e.g. to provide hydrogen, which is the fuel that is supplied to and consumed directly by the fuel cell.

Where ammonia is used as the fuel with which the fuel cell is fed this may be delivered either as ammonia gas, or an aqueous solution of ammonia, for example at concentrations of from about 0.001 M to that at which the solution is saturated. Either ammonia gas or aqueous solutions of the ammonia may be generated from a reservoir of liquid ammonia if this is convenient. Alternatively solutions of ammonium salts such as ammonium chloride, nitrate, sulfate, acetate or oxalate may be used. Typically, such salts are not employed, however, since the resultant acids formed upon oxidation of the ammonium ion can damage the hydroxide-containing polymeric electrolytic membrane. As a still further alternative, ammonium salts comprising an ion that yields carbon dioxide, such as ammonia bicarbonate, ammonium carbonate and ammonium carbamate, may be used in accordance with this invention.

Where urea is used as a fuel, this may be conveniently introduced into the fuel cell as an aqueous solution. There is no particular limit to the concentration of urea that may be used; any convenient concentration could be used from about 0.01% or about 1% w/v, or about 10% w/v, up to the concentration at which an aqueous solution of urea is saturated. Alternatively, formulations other than solutions of urea could be employed such as pastes or gels (typically with water as continuous phase) with these being manipulated into the fuel cell by use of a suitable pumping apparatus. As is known commercial urea is often accompanied by certain contaminants and the term “urea” is not intended to require the presence of urea in the absence of these contaminants, which can include one or more of ammonia carbamate, carbonate, bicarbonate, formate and acetate.

In certain embodiments of the invention one or more soluble inorganic or organic hydroxides, bicarbonates and carbonates, such as quaternary ammonium hydroxide, alkali hydroxide NH₄HCO₃, (NH₄)₂CO₃, NaHCO₃ and Na₂CO₃ can be added to the fuel in order to increase the ionic conductivity of anion-conducting membrane and to decrease the anode polarisation resistance.

A particularly convenient aspect of the present invention is that there are pre-existing commercial distribution networks that exist for the supply of urea for use in agriculture as a fertiliser and as an additive to trap nitrous oxide in automobiles. An example of such a commercially available urea solution, suitable for use according to the present invention, is that available commercially as a 32.5% solution in water sold under the trade name AdBlue, a pure aqueous solution of urea used in commercial diesel vehicles for the removal of nitrous oxide.

Alternatively, urea fuel cells can use urine as the fuel. Used in this way, urine, a product of human/animal excretion, is not a waste, but an energy source. For every adult producing 1.5 litres of urine per day, containing 2 wt % urea, 11 kg of urea is produced each year. This is equivalent to the energy in 18 kg of liquid hydrogen that can be used to drive a car for 2700 km

Ammonia is also a commonly used industrial and agricultural chemical that can be handled safely.

Suitable apparatus for delivery in the case of ammonia, by way of steel or stainless steal conduits, such as tubes, will be evident to those skilled in the art. Likewise, those skilled in the art will be aware of how to construct apparatus that allow manipulation of solutions of ammonia salts or of urea, for example. Generally the fuel may be introduced by gravity feed or by pumping.

At the cathode, the oxidant may be any oxygen-containing species that can provide hydroxide anions upon reduction. Conveniently, and typically, the oxidant may be oxygen itself, and may be conveniently supplied as air. Alternatively, purified oxygen may but need not necessarily be used. The oxidant may be gaseous or liquid. Typically, in particular where hydroxide (or bicarbonate) ions are used as the conducting species passing through the electrolyte to the anode, liquid water or steam is supplied with the oxidant to the cathode. In addition to the oxidant, if it is desired for bicarbonate or carbonate to be used as the conducting species passing through the electrolyte to the anode, carbon dioxide may advantageously introduced at the cathode in addition to the oxidant, either as such or by way of its presence in air.

As is known in the art a fuel cell stack is a plurality of fuel cells configured consecutively or in parallel, so as to yield either a higher voltage or allow a stronger current to be drawn. The present invention contemplates the use of fuel cell stacks in practising the methods and according to the other embodiments of the present invention.

The present invention is of use in allowing generation of electricity for supply to a variety of devices, which may be stationary or non-stationary. The device may or may not, but typically does, comprise the fuel cell, or fuel cell stack, operated according to the present invention. Stationary devices may be non-portable devices such as fixed machinery or, more typically, portable devices such as mobile telephones, digital cameras, laptop computers or portable power packs where use of the present invention may allow the replacement or complementing of existing battery technology. In particular embodiments of the invention the methods may be used to power non-stationary devices such as vehicles, e.g. cars. Further examples of specific embodiments of the invention include under-water vehicles such as submarines, and rocket and other aeronautical applications. The invention can also be used to clean up municipal waste water and generate electricity. Based on this invention, it is possible to develop renewable and sustainable urine fuel cells.

The invention thus provides for direct urea/urine, and ammonia or ammonium salt fuel cells based on low-cost alkaline membrane electrolytes and non-noble catalysts such as nickel, silver and MnO₂. For stationary power generation, high power density is not a stringent requirement as long as the cost of the cell itself is low. High power can be achieved by using enlarged fuel cell area or increased numbers of single cells.

One of the advantages of the present invention is that the methods can if desired be practised at considerably lower temperatures that those, for example reported by Ganley et al. (infra) of between 200 and 450° C. Thus, the methods of the present invention may be practised at temperatures as low at about ambient temperature (about 20 to 25° C.) up to about 150-200° C., Typically the methods are practised at temperature in the range of about 5 to about 200° C., e.g. 15 to about 150° C. In certain embodiments the method may desirably be practised at temperature more than about 20° C., more than about 50° C. or more than about 80° C.

The invention is illustrated by the non-limiting examples that follow below:

Thermodynamic parameters for calculation of theoretical open circuit voltage (OCV) and efficiency.

### Reaction:

2CO(NH₂)2+30₂-7 2N₂+2CO₂+4H₂O

| Compounds | CO(NH₂)₂(c) | O₂ (g) | N₂ (g) | CO₂ (g) | H₂O (l) |
|---|---|---|---|---|---|
| ΔG°_{f}(kcal/mol) | −47.19 | 0 | 0 | −94.254 | −56.687 |
| ΔH°_{f}(kcal/mol) | −79.71 | 0 | 0 | −94.051 | −68.315 |
| S° (cal/K · mol) | 25.00 | 49.003 | 45.77 | 51.06 | 16.71 |
| C°ₚ(cal/K · mol) | 22.26 | 7.016 | 6.961 | 8.87 | 17.995 |

* Data from CRC Handbook of Chemistry and Physics, Editor: R. C. Weast. 63^{th} Edition. CRC Press, Inc. Boca Raton, Florida. 1983.

Thermodynamic value of urea dissolution in water:

| Compounds | CO(NH₂)₂ dissolution |
|---|---|
| ΔG°_{f}(kcal/mol) | −6.86 |
| ΔH°_{f}(kcal/mol) | −14 |
| S° (cal/K · mol) | 69.5 |
| C°ₚ(cal/K · mol) | 4.31^{§} |

*Data from: Charles A. Liberko and Stephanie Terry, A Simplified Method for Measuring the Entropy Change of Urea Dissolution, J. Chem. Edu., 78, 1087-1088 (2001).
^{§}Assuming heat capacity of dilute urea solution equals to that of water.

During the estimation, it has been assumed that thermal capacitances of compounds do not change in the temperature range. In a real situation, they do change but will have little contribution to free energy change.

### Example 1

The following alkaline membrane-containing fuel cells were constructed:

### Preparation of a Composite Membrane Based on a Commercial Anion Exchange Resin:

Poly vinyl alcohol (PVA), molecular weight 50,000 (Aldrich) (2 g) was put in a glass beaker. 12 ml deionised water was added into the beaker to mix with PVA. Then the mixture was heated at 85° C. for 2 hours (water bath) until a gel was obtained. After cooling to room temperature, the gel was stored for further use. 2 grams commercial anion exchange resin MTO-Amberlite-IRA-400 (Aldrich) was put into an agate mortar and ground into powder. The PVA gel was transferred into the motar to mix together with the resin powder to form a mixture. After casting the mixture on a glass plate, drying at room temperature in air (or in vacuum oven) for overnight, a composite membrane was formed for membrane electrolyte assembly (MEA) for an AMFC. The membrane can be stored in 0.5M NaOH solution for future use. After taking out from the NaOH solution, the membrane can be washed by water for several time before using for MEA.

### Cell A

Polytetrafluororoethylene (PTFE) (Aldrich, 60 wt % dispersion and water) and KOH with a weight ratio of 50:50 were mixed and dried at 150° C. for 15 minutes. The resultant PTFE-KOH composite was pressed into a membrane and used as an electrolyte.

The membrane electrode assembly (MEA) was fabricated with MnO₂/C (20 wt % MnO₂) cathode and nickel anode. These were manufactured as follows:

The cathode was prepared from KMnO₄, Mn(CH₃COO)₂ and carbon (Cabot Valcun XC72R) a co-precipitation method as described by C Xu et al., (J. Power Sources, 180, 664-670 (2008)).

The nickel anode was prepared from NiCl₂.6H₂O and KBH₄ according to S F Lu et al., (Proc. Natl. Acad. Sci. USA, 105, 20611-20614 (2008)). Some trisodium citrate was added into aqueous NiCl₂ solution in order to obtain nano-sized nickel particles (nickel particle size about 2 nm) as observed with TEM. The as-prepared nickel was mixed with carbon in a 50:50 weight ratio and used as the anode.

The loading of the cathode and anode were 20 mg/cm² and 10 mg/cm² respectively.

Carbon paper (Toroy 090, E-TEK) was used as current collector for both cells.

### Cell B

Commercial strong basic anion exchange resin MTO-Amberlite-IRA-400 (Aldrich) was used as OH− ion conducting component. The weight ratio of MTO-Amberlite-IRA-400 and PVA is 50:50. PVA was dissolved in deionised water by heating at a temperature ˜85° C. for form a PVA gel. The anion exchange resin crushed into powders then mixed with the PVA gel, casted on glass plate, dry at room temperature for overhight to form a composite membrane which will be used for MEA. A 60 weight % PtRu/C (E-TEK) was used at anode at a loading of 1 mg/cm² and MnO₂/C (20 wt % MₙO₂) was used as cathode. The cathode was the same as used in Cell A.

### Cell C

The alkaline membrane was made from a blend of chloroacetyl poly(2,6dimethyl-1,4-phenylene oxide) (CPPO) synthesized by a method described by L Wu et al, (J. Membr. Sci, 310, 577-585 (2008)). The CPPO synthesised was blended with polyvinyl acetate (PVA) (in the gel form as described in Cell B) in a weight ratio of 50:50 to form composite membrane, which was put in trimethylamine for cross-linking for 24 hours followed by immersion in a 2 M KOH solution in water for 24 hours for anion exchange before using as an electrolyte.

The electrodes were as described in Cell A.

### Operation of the Fuel Cells

Hydrogen, ammonia, ammonia solution and urea solution (Ad Blue) were used as the fuels for the fuel cell tests and oxygen as the oxidant supplied to the cathode. The oxygen was passed through water at room temperature before entering the fuel cell. The water can be at ambient temperature or supplied to the cathode as steam.

If CO₃²⁻/HCO₃⁻ ions serve as the anion in the solid alkaline membrane, carbon dioxide is also supplied to the cathode. This may supplied as such or is supplied in air. A Solartron 1287A electrochemical interface incorporated with a CorrWare/CorrView software was used to measure fuel cell performance.

### Results:

### Comparison of Open Circuit Voltage (OCV) and Efficiency of Ammonia/Oxygen and Hydrogen/Oxygen Fuel Cells

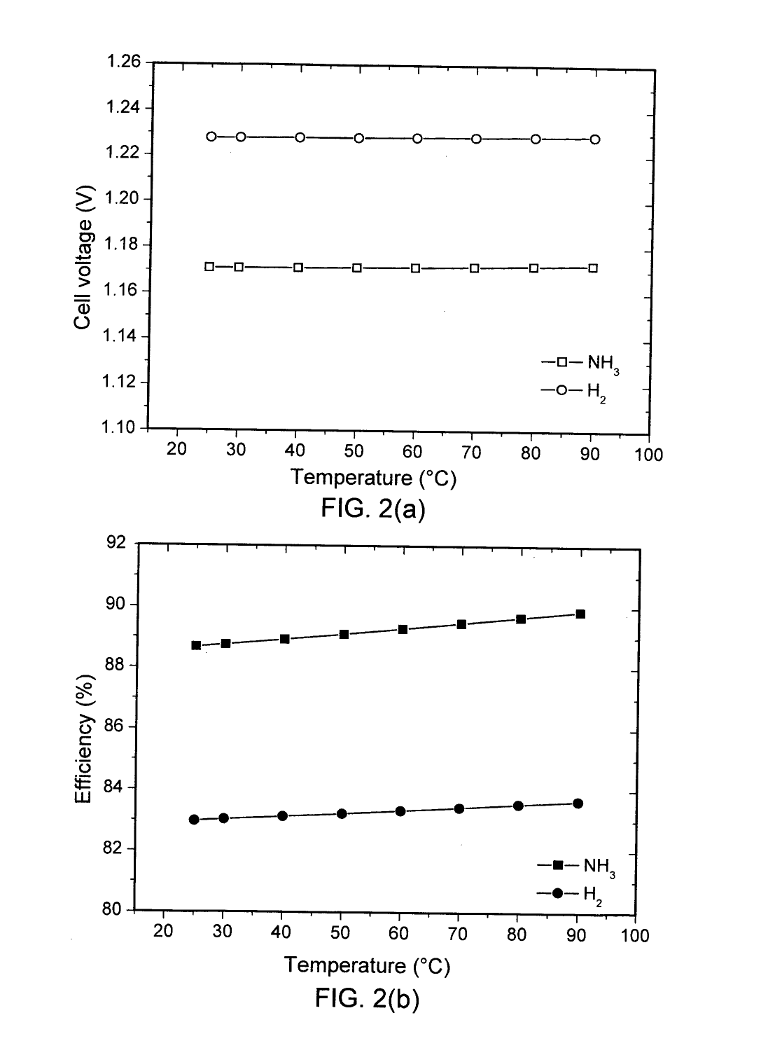

As depicted in FIG. 2(a) the theoretical OCV of ammonia/oxygen fuel cell is 1.17 V at room temperature, slightly lower than that of 1.22 V for a hydrogen/oxygen fuel cell at the same temperature. It will be noted that these OCVs do not vary great in the temperature range 20-90° C.

Despite the lower theoretical OCV of the ammonia/oxygen fuel cell, the theoretical efficiency of the fuel cell is 88.7% at room temperature (25° C.) which is slightly higher than that of hydrogen/oxygen fuel cell (83%) at the same temperature. Accordingly, it is clear that operation of a direct ammonia fuel cell is feasible even at room temperature.

### Operation of Cell A

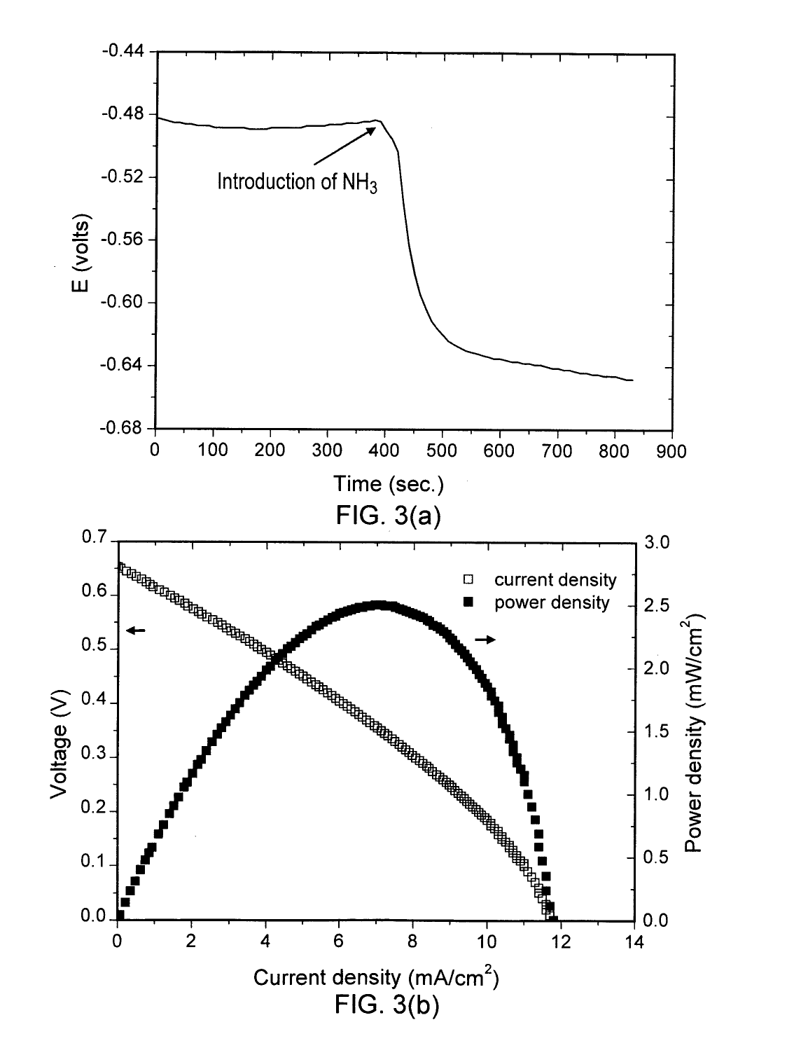

These results are depicted in FIG. 3(a) and (b).

FIG. 3(a) shows the OCV change against time during the operation of cell A and shows an initial OCV of 0.48 V observed in air. This is the potential difference between the nickel anode and MnO₂ cathode. Introduction of wet oxygen has no significant effect on the OCV. However, when ammonia was introduced at the anode side of a fuel cell, the OCV decreased immediately indicating the nickel is an active catalyst to convert ammonia to nitrogen and water in alkaline media, even at room temperature.

FIG. 3 (b) shows the ammonia/oxygen fuel cell performance for Cell A. A maximum current of density of 11.6 mA/cm² and power density of 2.5 mW/cm² was achieved at room temperature. It will be noted that the OCV of Cell A is still lower the theoretical value (see FIG. 2(a)), this being believed to being due to electrode polarisation. Enhancement of the OCV may be achieved by routine material composition and microstructure optimisation.

It should be noted that operating the cell below the initial OCV generated by the nickel and MnO₂ electrodes should be avoided because nickel can be oxidised in parallel with the ammonia.

### Operation of Cell B

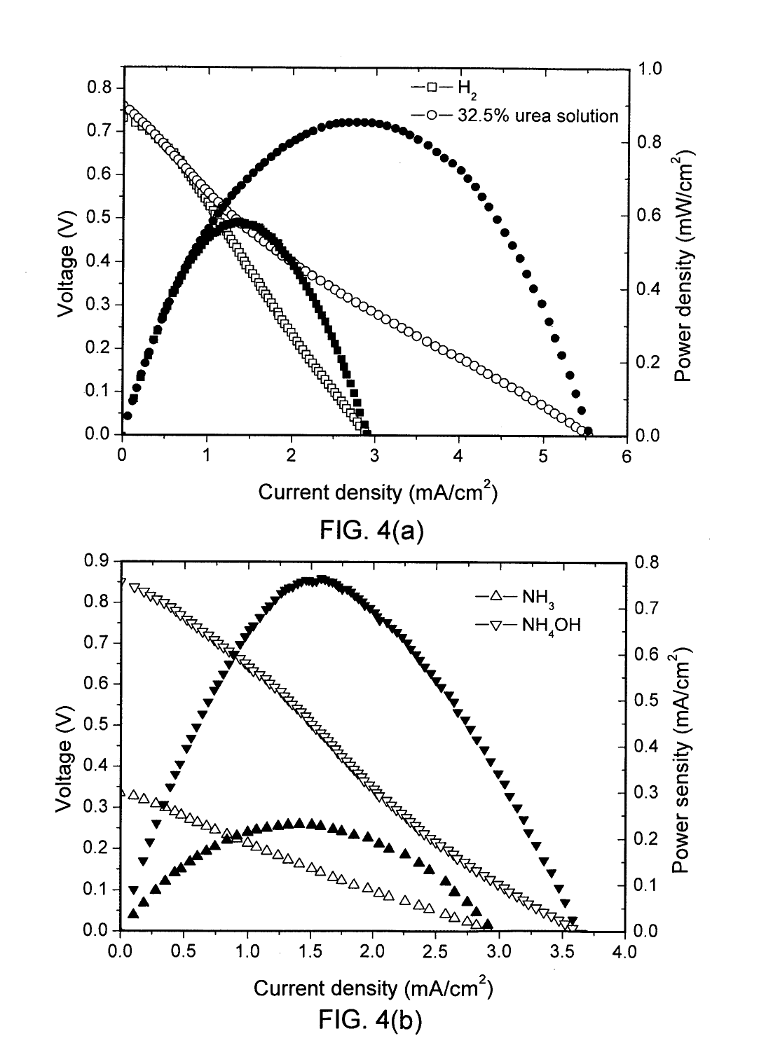

FIG. 4 depicts the fuel cell performance for Cell B which was similar to Cell A but based upon PtRu/C anodes. At room temperature, the OCV of cell B is 0.74 V with a maximum current density 2.9 mA/cm² when H₂ was used as the fuel (FIG. 4a). Similar OCV was achieved but the maximum current density doubled when AdBlue (32.5% urea aqueous solution) was directly used as the fuel. FIG. 4b shows the performance of Cell B when ammonia and ammonia solution were used as the fuel respectively. The OCV reached 0.85 V when ammonia solution was used. Ammonia gas can also be used as fuel but the performance is lower than that for ammonia solution. In conclusion, hydrogen, ammonia, ammonia solution and urea solution can all be used as fuel for AMFCs. Reasonable performance can be achieved at room temperature.

These experiments show that, at the loading used in the cells, nickel exhibited comparable (if not better) activity to platinum at room temperature when used as an anode for a direct ammonia fuel cell.

### Operation of Cell C

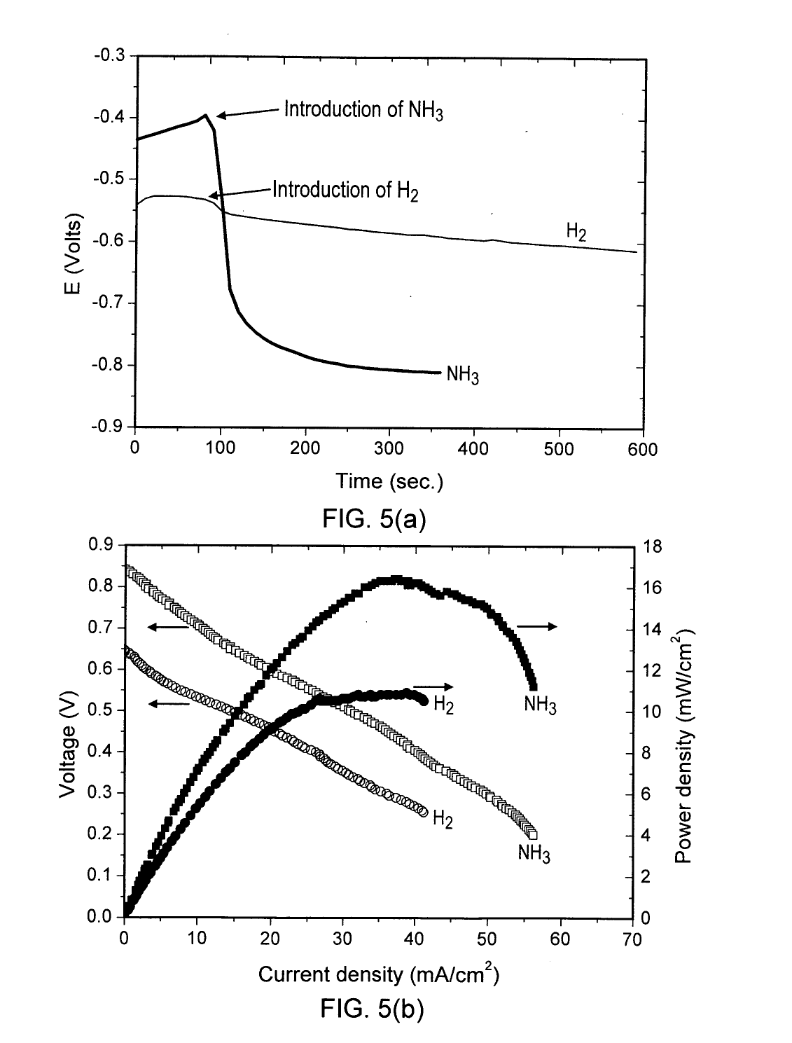

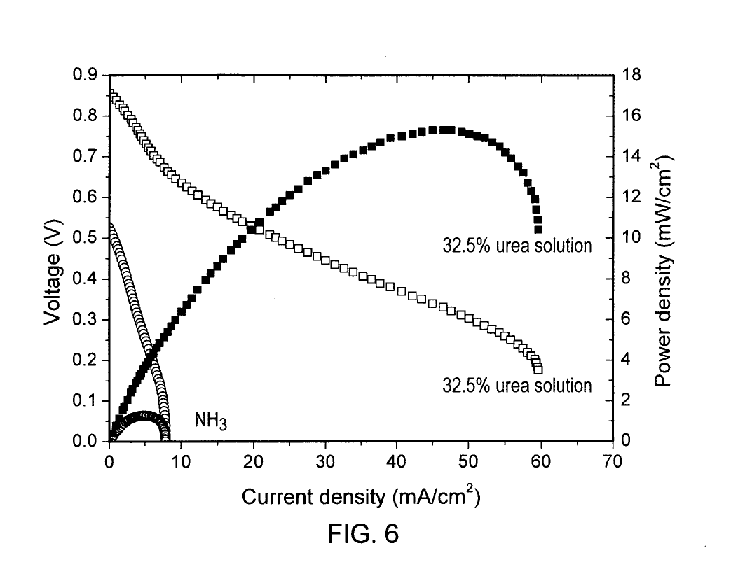

FIG. 5(a) shows how the OCV changes when hydrogen and ammonia were used as the fuel when operating Cell C. It can be observed that the kinetic process of the electrode is quite slow at room temperature when hydrogen is used as fuel, with the OCV reaching 0.61 V after 10 minutes when hydrogen was used as the fuel. With ammonia, however, the electrode process is faster with the OCV reaching 0.81 V within 6 minutes. It is assumed that the difference in OCV of the cell with the two different fuels is due to the catalytic process at the anode since the cathode is the same. Nickel is thus demonstrated therefore as a very good anode for both room temperature ammonia fuel cells and the catalytic process is as good (if not better than) that observed with the fuel cell operated using hydrogen as fuel.

FIG. 5(b) shows the performance of the cell with the two different types of fuel. The cell exhibited reasonable performance even at room temperature. The OCV of the cell using hydrogen and ammonia as fuel was 0.65 V and 0.84 V respectively. At room temperature, the maximum power densities were 10.8 and 16.4 mW/cm² for hydrogen and ammonia respectively. Compared with hydrogen, therefore ammonia is in fact as good a fuel in an alkaline membrane fuel cell.

### Example 2

### Preparation of Alkaline Membrane

The composite membrane was made of a commercial strong anion exchange resin (AER) (Amberlite IRA 78, hydroxide form, Aldrich) and polyvinyl alcohol (PVA), (MW 50,000, Aldrich) at a weight ratio of 60/40. PVA was dissolved in de-ionised water and stirred at 85° C. for two hours to form a gel. After the gel was cooled down to room temperature, the commercial resin was crushed into powder in an agate mortar first then mixed with PVA gel, cast on a glass plate and dried in a vacuum oven at room temperature to form an AER-PVA blend membrane.

### Cell D

Membrane electrode assemblies (MEAs) for fuel cells measurements were fabricated with a Pt/C anodes and AER-PVA blend membrane. Pt/C (30 wt %, E-TEK) was used as anode at a loading of 0.6 mg/cm². Carbon papers (Toray 090, water-proofed for anode, plain for cathode, E-TEK) were used as current collectors.

### Cell E

Nano-sized nickel was prepared, according to S Lu et al., (infra), from NiCl₂.6H₂O (Alfa, 99.3%), CrCl₃.6H₂O (Alfa, 99.5%) and KBH₄ (Alfa, 98%). Some trisodium citrate was added into the NiCh aqueous solution in order to obtain nano-sized nickel particles (primary particle size ˜2 nm). The nickel was dried at room temperature only. The as-prepared nano-sized nickel was mixed with carbon (Carbot Vulcan XC-72R) at a 50/50 weight ratio to be used as anode. Nano-sized silver was prepared by a similar method to that for preparation of nickel using AgNO₃ (Alfa, 99.9+%) as the precursor. The silver was mixed with carbon (Cabot Vulcan XC-72R) by a weight ratio of 50/50. The loading of Ag at cathode and Ni at anode were ˜20 mg/cm². The other parameters are the same as in Cell D.

### Cell F

The same Ni/C anode as in Cell E was used. 20 wt % MnO₂/C was prepared from KMnO₄ (Avacado, 99%), Mn(CH₃COO)₂.4H₂O (Aldrich, 99.99%) and carbon (Cabot Vulcan XC-72R), by a co-precipitation method according to C Xu et al., (infra). The loading of MnO₂ at cathode and Ni at anode were ˜20 mg/cm². The other parameters are the same as in Cell D.

### Operation of the Fuel Cells

Urea solution at different concentrations was prepared from urea (Alfa Aesar, ACS grade) and de-ionised water. Commercial AdBlue (32.5% urea solution) supplied by a local garage. Human urine were also used as fuel for fuel cell tests. Urea solutions were pumped into the anode side by a peristaltic pump (Watson Marlow 323D). Wet air was supplied to the cathode by passing air through room temperature water. The cell area was 1 cm². A Solartron 1287A electrochemical interface coupled with a CorrWare/CorrView software was used to measure the fuel cell performance.

### Results:

### Comparison of Open Circuit Voltage (OCV) and Efficiency of Urea/Oxygen and Hydrogen/Oxygen Fuel Cells

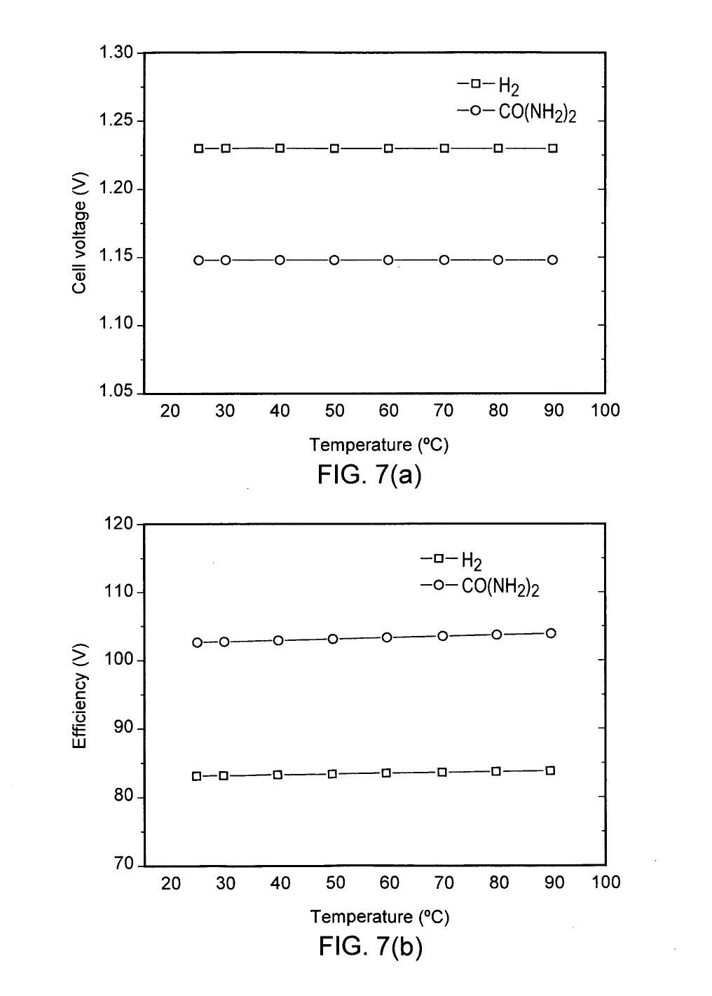

The theoretical OCV and the efficiency of hydrogen and urea fuel cells at a temperature range of 25-90° C. have been estimated through available thermodynamic data (FIGS. 7(a) and 7(b)).

As depicted in FIG. 7(a) the theoretical OCV of urea/oxygen fuel cell is 1.146 V at room temperature, slightly lower than that of 1.23 V for a hydrogen/oxygen fuel cell at the same temperature. It will be noted that these OCVs do not vary greatly in the temperature range 20-90° C.

Despite the lower theoretical OCV of the urea/oxygen fuel cell, the theoretical efficiency of the fuel cell is 102.9% at room temperature (25° C.), which is about 20% higher than that of hydrogen/oxygen fuel cell (83%) at the same temperature (see FIG. 7(b).

The high theoretical efficiency of a urea fuel cell is due to the positive entropy change of reaction. When the efficiency is over 100%, physically, the fuel cell absorbs heat from ambiance and converts it completely into electricity together with the chemical energy of the reactants alleviating the heat exchange issue as in the case of conventional hydrogen PEMFCs (S. G. Kandlikar, Z. J. Lu, Appl. Thermal Eng., 2009, 29, 1276.)

### Operation of Cells D to E

Urea fuel cells, using an alkaline membrane, were investigated using either Pt/C as both electrodes (Cell D); a non-noble Ni anode and an Ag/C cathode (Cell E) or a Ni/C anode and a MnO₂/C cathode (Cell F).

### Operation of Cell D

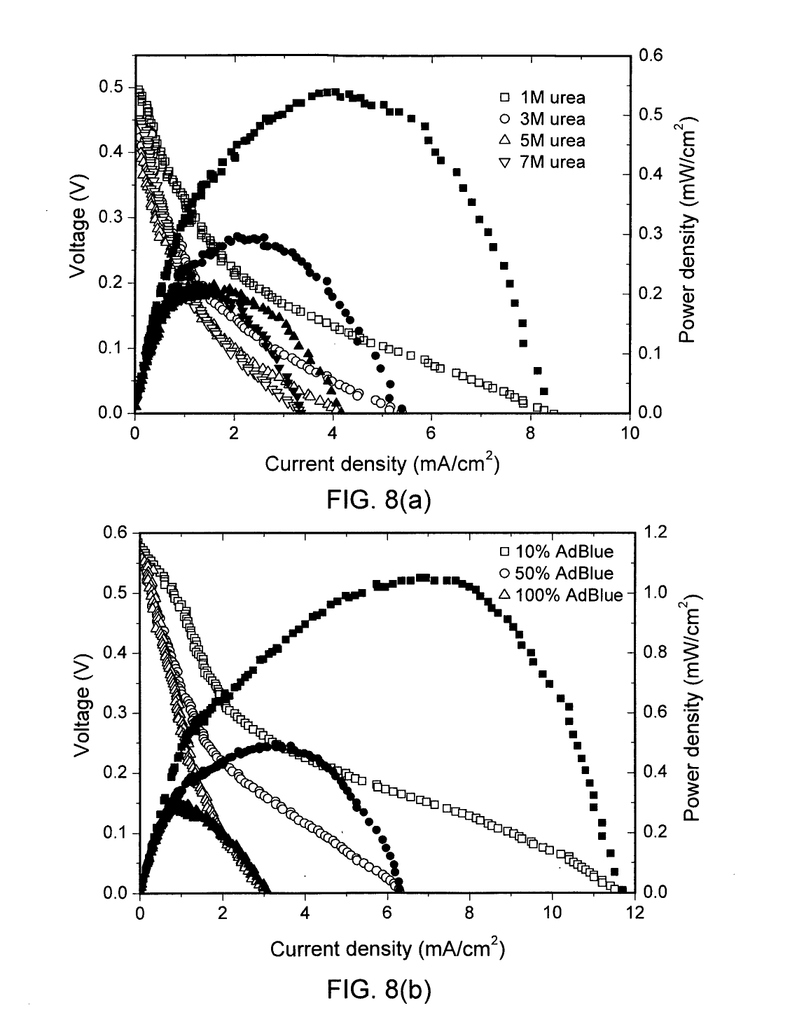

The urea/air fuel cell performance for Cell D is depicted in FIG. 8(a) and (b).

FIG. 8(a) shows an OCV of 0.5 V was observed for urea/air when a 1 M urea aqueous solution was used as the fuel. The lower OCV at room temperature indicated that the catalytic activity of Pt at room temperature caused a polarisation loss on both electrodes. The OCV of the cell decreased when 3M and 5M urea solutions were used. The performance of a dilute urea solution has also shown to be higher, indicating a high concentration is not necessary under the operating conditions.

In order to confirm this phenomenon, a different urea source was used in the fuel cell. FIG. 8(b) shows fuel cell performance when AdBlue, a commercial 32.5% (˜5 M) urea aqueous solution was tested. Higher OCVs were observed for comparable urea concentrations when various concentrations of AdBlue were used as the fuel. The maximum power density was 0.3 mW/cm² for AdBlue, higher than the 0.2 mW/cm² achieved when 5 M urea was used (FIG. 8(a)). High power density benefits from the relative higher voltage although the maximum current density is slightly lower. These experiments indicate that the trace amounts of impurities in different sources of urea impact on fuel cell performance.

When AdBlue solutions at different concentrations (by adding de-ionised water) were used as the fuel, the same trends were observed as for the urea solutions; the dilute AdBlue solutions exhibited better performance than pure AdBlue. The 10% AdBlue solution exhibits the highest current and power densities. The urea concentration of the 10% AdBlue solution has the same level of urea as urine, indicating that urine could be a good fuel.

### Operation of Cell E

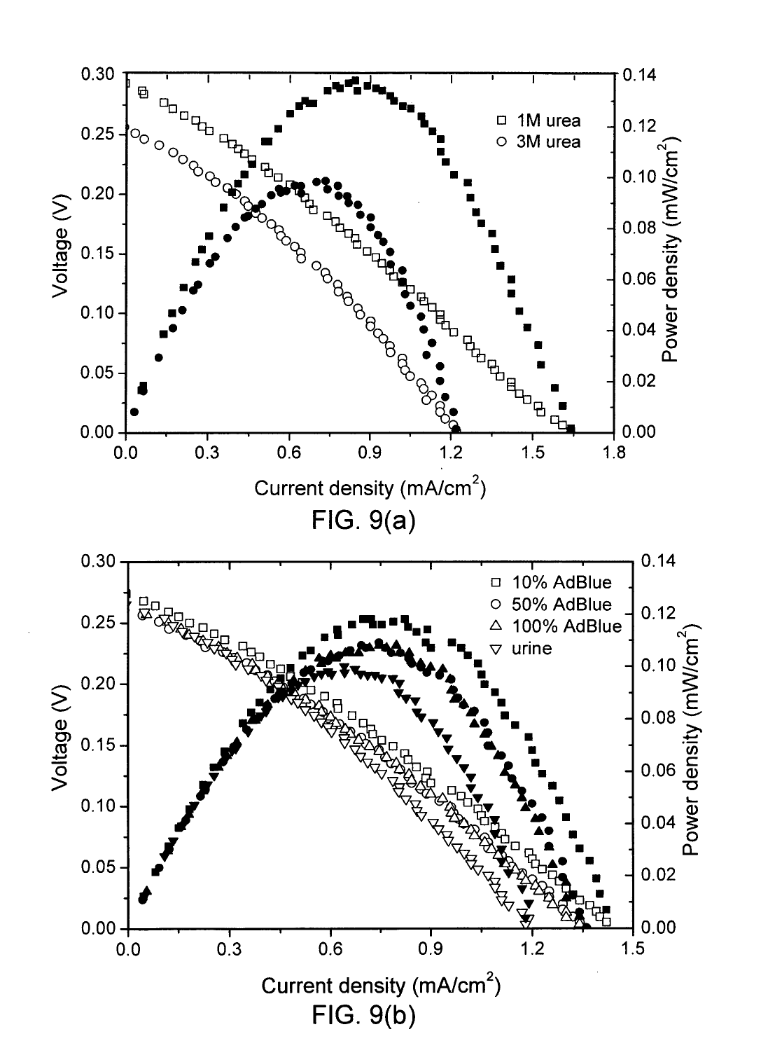

One of the advantages of alkaline membrane fuel cells is that low-cost catalysts can be used as electrodes. Cells E and F were constructed using Ni/C as anode, Ag/C or MnO₂/C as cathode as described in detail above. For Cell E, at room temperature, an OCV of 0.29V was observed when a 1 M urea solution was used as fuel, which is lower than the 0.5 V achieved when Pt/C was used at both electrodes. The power density is about 75% lower than in Cell D indicating Pt is still a better catalyst for urea fuel cells. Performance was again lowered when a 3 M urea solution was used (FIG. 9(a)). AdBlue at different concentrations was also used as the fuel. As was noticed with Cell D, dilute AdBlue solutions exhibit better performance (FIG. 9(b)). The performance of human urine was also tested as fuel for Cell E. It was found that the performance is slightly lower than that for AdBlue but comparable with a 3 M urea solution. This result indicates that urine can be used for fuel cells.

### Operation of Cell F

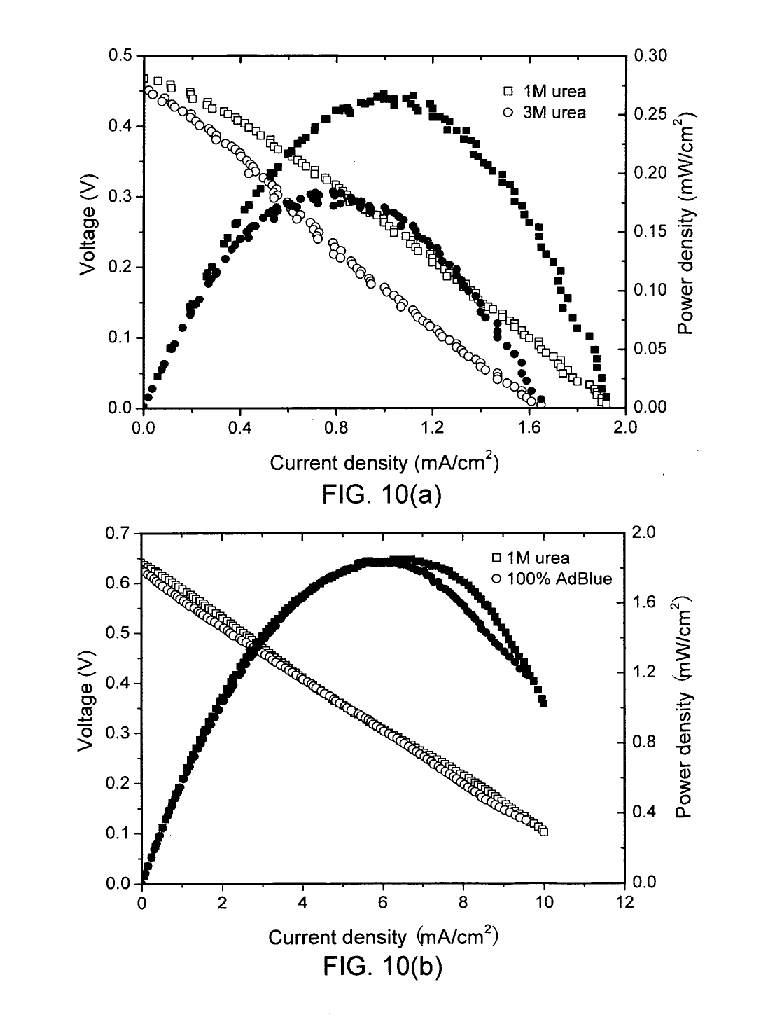

With Cell F, where MnO₂/C was used as the cathode, the OCV of the cell was higher than that of the cell when Ag/C was used (FIG. 10(a)). The power density is also slightly higher which benefits from the relatively higher OCV.

In general, the catalytic activity on electrodes increases at elevated temperatures. This is confirmed by the higher OCV and power density when the operating temperature of Cell F was increased to 50° C. A maximum power density of 1.7 mW/cm² was achieved using a 1 M urea solution as the fuel (FIG. 10(b)). This is six times higher than that of the cell operating at room temperature (FIG. 10(a)). Performance of alkaline membrane fuel cells based on low-cost catalysts at 50° C. is better than those using Pt electrodes at room temperature. Higher operating temperature is desired when low-cost catalysts are used in urea fuel cells. The performance of AdBlue is almost identical to the 1 M urea solution indicating that AdBlue can also be used as fuel for Cell F based on low-cost catalysts.

1. A method of operating a fuel cell comprising a solid anion exchange membrane, the method comprising contacting an anode in the fuel cell with urea, ammonia or an ammonium salt and contacting the cathode with an oxidant whereby to generate electricity.

2. The method of claim 1 wherein the solid anion exchange membrane comprises hydroxide ions.

3. The method of claim 1 wherein the solid anion exchange membrane comprises carbonate and/or bicarbonate ions.

4. The method of claim 1 wherein the solid membrane comprises a metal hydroxide-doped polymer or a permanently charged polymer comprising polymer-bound cations and hydroxide counterions.

5. The method of claim 4 wherein the solid membrane comprises a permanently charged polymer comprising polymer bound cations and hydroxide ions.

6. The method of claim 4 wherein the polymer-bound cations comprise quaternary ammonium ions.

7. The method of claim 1 wherein the solid membrane further comprises one or more neutral polymers.

8. The method of claim 7 wherein one or more neutral polymers are selected from the group comprising PVC, PVA, PEG, PVB, PTFE and PVDF.

9. The method of claim 1 wherein the solid membrane comprises a blend of an alkaline anion exchange resin or polymer and PVA in a w/w ratio of from about 20:80 to about 80:20.

10. The method of claim 1 wherein the anode comprises nano-sized nickel-containing or metal nitride-containing particles.

11. The method of claim 10 wherein the anode comprises a metal nitride such as cobalt molybdenum nitride.

12. The method of claim 10 wherein the nano-sized particles have particle sizes of about 2 nm.

13. The method of claim 1 wherein the cathode comprises nano-sized particles of a manganese oxide, a nickel alloy, nickel foam or of a nickel-containing oxide.

14. The method of claim 13 wherein the cathode comprises nano-sized particles of manganese dioxide or of a nickel-containing oxide.

15. The method of claim 13 wherein the catalysts are formed from powders, mesh, foam, or powders mixed with a conducting material such as carbon powder, carbon paper, carbon cloth, nickel mesh, nickel foam or plated nickel foam.

16. The method of claim 1 wherein ammonia is introduced into the fuel cell as ammonia gas or aqueous ammonia.

17. The method of claim 16 wherein an ammonium salt is introduced into the fuel cell and is selected from ammonium carbonate, ammonium bicarbonate and ammonium carbamate.

18. The method of claim 1 wherein urea is introduced into the fuel cell as an aqueous solution.

19. Use of urea, ammonia or an ammonium salt as a direct fuel for a fuel cell comprising a solid hydroxide ion exchange membrane.

20. The use of claim 19, which comprises a method of operating a fuel cell comprising a solid anion exchange membrane, the method comprising contacting an anode in the fuel cell with urea, ammonia or an ammonium salt and contacting the cathode with an oxidant whereby to generate electricity.

21. A fuel cell comprising a solid hydroxide ion exchange membrane, for example as defined in claim 1, and urea, ammonia or an ammonium salt.

22. A fuel cell stack comprising at least two fuel cells as defined in claim 21.

23. A method of powering a device comprising carrying out a method of operating a fuel cell according to claim 1 and using the electricity generated thereby to power the device.

24. The method of claim 23 wherein the device is a vehicle or a submarine.

25. A solid anion exchange membrane comprising a blend of an alkaline anion exchange resin or polymer and PVA in a w/w ratio of from about 20:80 to about 80:20.
